(19) United States
(12) Patent Application Publication
(10) Pub. No.: US 2009/0257474 A1
(43) Pub. Date: Oct. 15, 2009

(54) Fast hop frequency hopping protocol

(75) Inventor: John R. Tuttle, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: KEYSTONE TECHNOLOGY SOLUTIONS, LLC, Boise, ID (US)

(21) Appl. No.: 12/103,291

(22) Filed: Apr. 15, 2008

(51) Int. Cl. H04B 1/713

(52) U.S. Cl. 375/133; 375/132; 375/135; 375/E01.033; 340/10.1; 375/E01.034

(57) ABSTRACT

Methods and apparatus, including computer program products, for a fast hop frequency hopping protocol. A method includes transmitting from a radio frequency identification (RFID) interrogator a continuous wave un-modulated radio frequency (RF) signal conforming to a fast hop frequency hopping protocol in which each hop of a plurality of hops spans at least one bit but less than the totality of bits to be sent from a single RFID device data in a single communications session.

### BACKGROUND

The present invention relates to radio frequency identification (RFID), and more particularly to a fast hop frequency hopping protocol.

RFID is a technology that incorporates the use of electromagnetic or electrostatic coupling in the radio frequency (RF) portion of the electromagnetic spectrum to uniquely identify an object, animal, or person. With RFID, the electromagnetic or electrostatic coupling in the RF (radio frequency) portion of the electromagnetic spectrum is used to transmit signals. A typical RFID system includes an antenna and a transceiver, which reads the radio frequency and transfers the information to a processing device (interrogator) and a transponder, or RF device, which contains the RF circuitry and information to be transmitted. The antenna enables the integrated circuit to transmit its information to the interrogator that converts the radio waves reflected back from the RFID device into digital information that can then be passed on to computers or processors that can analyze the data. These computers or processors can be housed within the interrogator or external to the interrogator. The computers, processors or interrogator can provide control or command information to the RFID device related to timing, operating methods, start methods, pulse methods and/or communications protocol selection parameters.

### SUMMARY

The present invention provides methods and apparatus, including computer program products, for a fast hop frequency hopping protocol.

In one aspect, the invention features a method including transmitting from a radio frequency identification (RFID) interrogator a continuous wave un-modulated radio frequency (RF) signal conforming to a fast hop frequency hopping protocol in which each hop of a plurality of hops spans at least one bit but less than the totality of bits to be sent from a single RFID device data in a single communications session.

In another aspect, the invention features a method including, in a radio frequency identification (RFID) interrogator, transmitting a command using a communication protocol to a RFID device, and receiving a response from the RFID device conforming to a fast hop frequency hopping protocol.

In another aspect, the invention features a radio frequency identification (RFID) interrogator including an integrated circuit, the integrated circuit coupled to a radio frequency (RF) transmitter through a digital-to-analog converter (DAC), the RF transmitter transmitting a continuous wave un-modulated radio frequency RF signal conforming to a fast hop frequency hopping protocol in which each hop of a plurality of hops at least spans one bit but less than the totality of bits to be sent from a single RFID device data in a single communication session.

In another aspect, the invention features a radio frequency identification (RFID) device including an antenna linked to a transmit/receiving circuit, the transmit/receiving circuit configured to receive a continuous wave un-modulated radio frequency (RF) signal from a RFID interrogator, the RF signal conforming to a fast hop frequency hopping protocol in which each hop of a plurality of hops spans at least one bit but has then the totality of bits to be sent from a single RFID device data in a single commitment session, and a microcontroller linked to the transmit/receiving circuit.

### BRIEF DESCRIPTION OF THE DRAWINGS

FIG. 1 is a block diagram of an exemplary radio frequency identification (RFID) system.

FIG. 2 is a block diagram of an exemplary RFID interrogator.

FIG. 3 is a block diagram of an exemplary timing diagram.

FIG. 4 is a block diagram of an exemplary RFID device.

FIG. 5 is a flow diagram.

Like reference numbers and designations in the various drawings indicate like elements.

### DETAILED DESCRIPTION

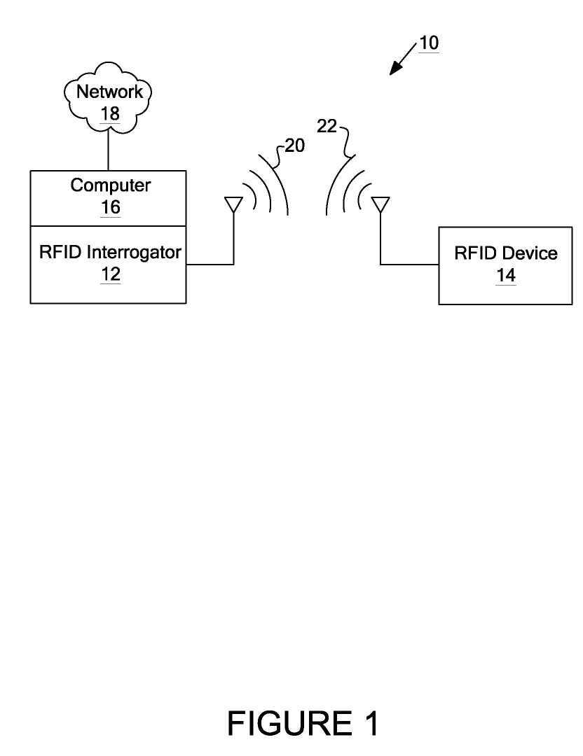

As shown in FIG. 1, an exemplary radio frequency identification (RFID) system 10 includes a RFID interrogator 12 and a RFID device 14. In this RFID system 10, the RFID interrogator 12 is controlled by a computer 16, whether internal or external, and the computer 16 is connected to a network 18. In RFID system 10, the RFID device 14 communicates to the RFID interrogator 12 using backscatter. More specifically, RFID interrogator 12 sends a radio signal 20 using a frequency protocol sometimes referred to as an air-interface protocol. This transmitted unmodulated signal is characterized by a frequency and power level. The frequency is usually set to fall within a band of frequencies allowed by regulatory authorities in a given jurisdiction. For example, in the United States, an RFID interrogator operating without a specific license will very likely use one of two Industrial, Scientific, and Medical bands allocated by the Federal Communications Commission (FCC): either 902-915 MHz, or 2.4-2.485 GHz. In Europe, the RFID interrogator most likely will operate within the 865-868 MHz band prescribed by ETSI recommendation EN 302 208. Each band may further be divided into channels a few hundred kHz wide, with the signal nominally centered within a channel in most cases.

There may be additional requirements on the use of these channels. For example, in the United States, a RFID interrogator is usually set up to hop in a random fashion from one channel or frequency to another channel or frequency in the band of frequencies, in order to ensure that all the channels are occupied uniformly and avoid interference on one specific part of a band. Frequency hopping is a method of transmitting radio signals by rapidly switching a carrier among many frequency channels, using a random sequence known to both the transmitter and the receiver.

More specifically, frequency hopping (also referred to as frequency hopping spread spectrum (FHSS)) is a technique used to prevent RFID interrogators from interfering with one another. In the United States, UHF RFID interrogators operate between 902 and 928 MHz, even though it is said that they operate in the middle of the band at 915 MHz. The RFID interrogators may jump or “hop” randomly or in a programmed sequence to any frequency between 902 MHz and 928 MHz. If the band is wide enough, the chances of two RFID interrogators operating at exactly the same frequency at the same time is small. The UHF bands in Europe and Japan are much smaller, so this technique is not as effective for preventing RFID interrogator interference.

In this slow hop frequency hopping method, sequential frequency hops are used by the RFID interrogator 12 in a pseudo-random order, each for a period of less than 400 milliseconds over any 30 second time average. The phrase, “slow hop” refers to an architecture used by most modern RFID systems, and particularly by those adhering to the EPCglobal standard in which the RFID interrogator 12 at a carrier frequency of about 900 MHz attempts to read many RFID device data bits and many RFID devices during one hop, in less than the approximately 400 microseconds.

In the EPCglobal protocol, the fastest symbol bit rate is approximately 640 KHz. It would be advantageous if an inventory process were faster. Here, an inventory process is a process in which a RFID interrogator identifies RFID devices that are in its field of view, such as RFID device 14. Most present designs for generating each reader frequency in a hopping sequence use phase locked loop (PLL) designs for frequency synthesizers, which generally take more than 200 microseconds to settle after changing to the next frequency. It would be advantageous to speed up or eliminate the settling time, thereby speeding up the hop rate for applications needing an increase in the number of communications sessions in a given time. Some designs have implemented multiple oscillators that are used alternately by switching in one, then the other, back to the first, and so on, to reduce the length of the time gap between hops. This can be complicated and expensive, introduce switching artifacts, and, because of long settling times, does not typically achieve the highest possible hop rates.

A frequency synthesizer using a digital waveform reconstruction with direct memory access (DMA) technique for frequency hopping spread spectrum (FH-SS) communication systems is much faster than a phase locked loop design, having no settling time and no off-time between hops. The DMA frequency synthesizer enables fast channel acquisition by using a simple memory table look-up technique. The technique simplifies the frequency control process and reduces the channel switching time. As a result, the channel efficiency can be improved.

UHF signals radiate away from the RFID interrogator antenna as waves. These waves can propagate long distances and interfere with the operation of nearby RFID interrogators (and other radio devices operating in the same band). The antennas usually employed are not terribly directional, and the radiated waves can bounce off objects and people, so that RFID devices on objects outside the “normal” read zone will occasionally be detected.

The RFID interrogator generates a signal (usually voltage or current) on a wire or cable. To convert that voltage to an electromagnetic wave, a transmitting antenna is needed. A passive RFID device talks back to the RFID interrogator by changing the amount of the RFID interrogator's signal that is reflected back to the RFID interrogator, or backscattered. In order to detect this backscattered signal 22, the RFID interrogator needs a receiving antenna. In bistatic configurations of RFID interrogators, two antennas are physically separate, though usually mounted in close proximity to one another. In a monostatic RFID interrogator a single antenna is used for both transmitting and receiving signals, with the aid of a specialized microwave device (e.g., a directional coupler or circulator) to extract the small received signal from the large transmitted signal.

The present invention improves communication speed and reliability of RFID systems by using fast hop frequency hopping (herein referred as “fast hop”), where each hop spans only one bit of single RFID device data instead of spanning many RFID device responses—perhaps thousands of bits—occurring during one hop, while the hops are occurring at very high rates, instead of slow rates (e.g., hopping every 400 milliseconds).

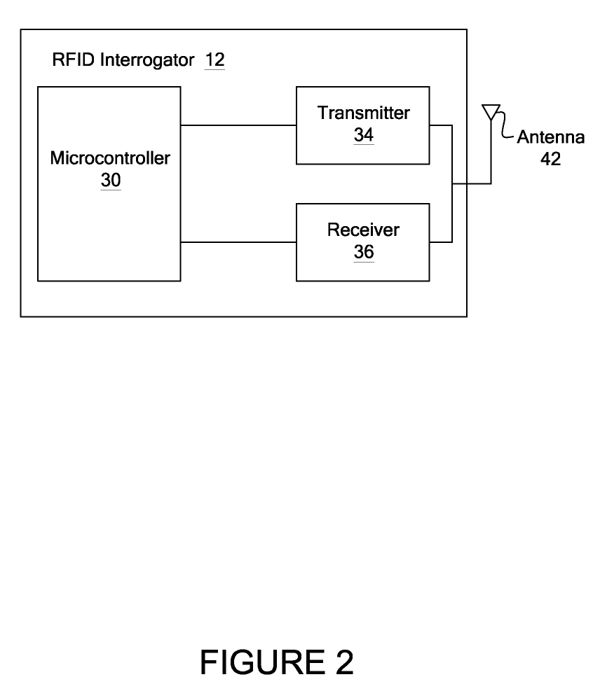

As shown in FIG. 2, the exemplary RFID interrogator 12 includes a microcontroller 30 connected to a RF transmitter 34 and a RF receiver 36. The transmitter 34 and receiver 36 are linked to an antenna 42. When interrogating the RFID device 14, digital signal data in accordance with information stored in the microcontroller 30 and information provided by a host application (not shown) is converted into analog signal data and transmitted to the RFID device 14 via the transmitter 34 and antenna 42. Back-scattered data is then received by the receiver 36 through the antenna 42, converted into digital data and provided to microcontroller 30 to be further processed, stored in memory, and/or provided to the computer 16.

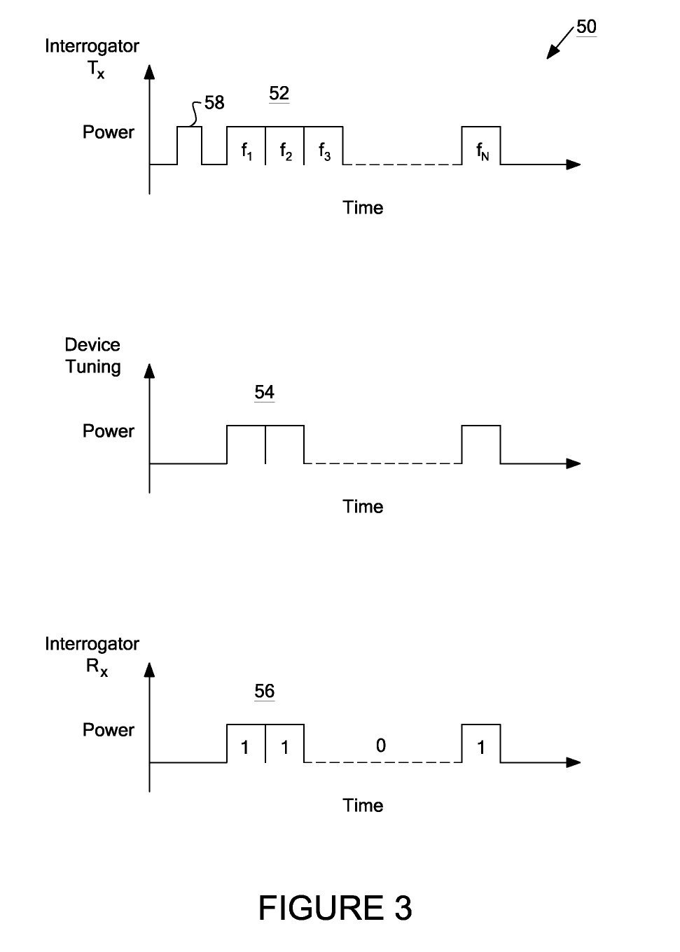

As shown in FIG. 3, an exemplary timing diagram 50 plots time (x-axis) against RF power (y-axis) using a fast hop frequency hopping process 100 and includes a RFID interrogator transmission (“reader Tₓ”) timing portion 52, a RFID device timing portion 54 and a RFID interrogator receiver (“reader Rₓ”) timing portion 56. A RFID interrogator sends out a start signal 58 (and possibly a timing pulse(s)) to a RFID device, which then begins to modulate (tune/detune) its antenna in synchronization with the RFID interrogator fast hop timing (i.e., f₁, f₂, f₂, . . . f_{N}), such that for each sequential bit of RFID device data, the RFID interrogator is transmitting and receiving at each hop. The RFID device tunes or detunes its antenna in time synch with the RFID interrogator hops depending on whether the RFID device is sending a logic “0” or logic “1,” or vice versa, by design. The RFID interrogator receiver keeps track of the data returned from the RFID device during a hop, so that the RFID interrogator can then reconstruct the data string from the RFID device after the fast hopping sequence is completed, or can add repeated strings or bits together to improve noise performance and reliability. This can be 10 to 100 times faster than previous slow hop methods, with frequency hops (i.e. tag, data bits) occurring at rates up to about 10 MHz to 50 MHz for operation under 900 MHz Part 15 rules; and up to about 100 MHz for operation under 2.45 GHz Part 15 rules. The start signal 58 can occur before each hop or can be present once at the beginning of a sequence of hops, with a certain dwell time for each hop, where the RFID device only needs to know how many bits to send, not the hopping sequence. Alternatively, the RFID device can continuously resend the data for a predetermined or indeterminate length of time or repeat a synchronized sequence multiple times.

The fast hop frequency hopping process 100 can be used in other examples. In one example, the RFID interrogator sends the RFID device a continuous wave (CW, i.e., non-modulating) power pulse for the purpose of charging the RFID device power supply, the RFID device responding in the fast hop manner of a fast hop frequency hopping process 100.

In another example, the RFID interrogator sends the RFID device a command using any communications protocol and the RFID device responds in the fast hop manner of fast hop frequency hopping process 100. The command may contain parameters, such as the number of repetitions or the hop rate, for example.

In another example, the RFID reader sends timing pulses to the RFID device using any communications protocol and the RFID device responds in the fast hop manner of fast hop frequency hopping process 100.

In another example, frequency doubling is used in conjunction with any of the above examples, for example, powering the RFID device at the doubled frequency while using the fast hop manner of fast hop frequency hopping process 100 at the fundamental carrier frequency. Doubling can be achieved with the rectifying diode used for the fundamental. A second antenna may also be added.

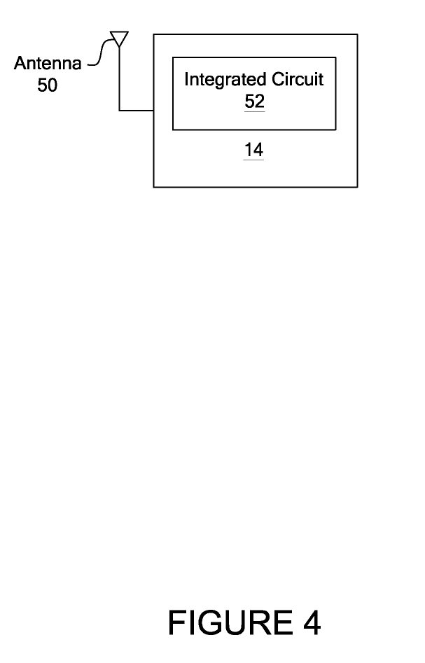

As shown in FIG. 4, the exemplary RFID device 14 includes an antenna 50 coupled to an integrated circuit 52. When triggered by RF interrogation, IC 52 (or application-specific integrated circuit or hard wired logic) fetches data and sends it out to the RFID interrogator 12 as multiplexed data packets.

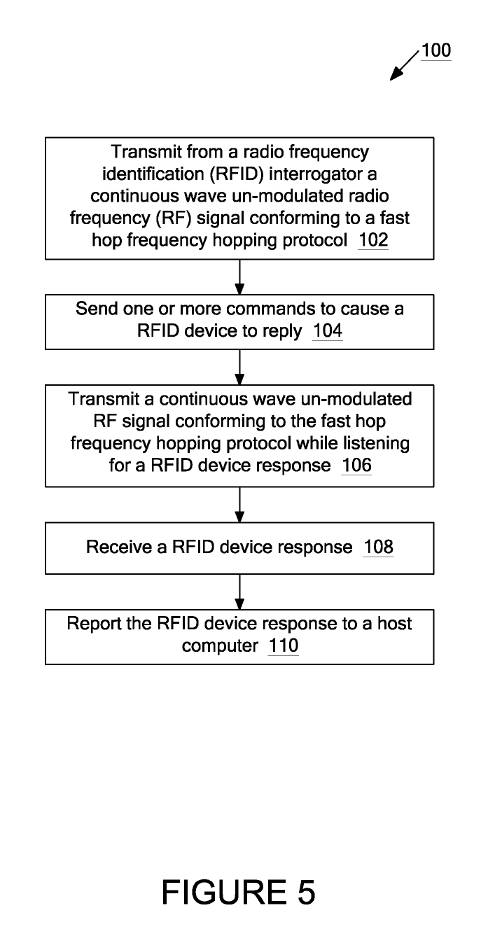

As shown in FIG. 5, fast hop frequency hopping the process 100 includes transmitting (102) from a radio frequency identification (RFID) interrogator a continuous wave un-modulated radio frequency (RF) signal conforming to a fast hop frequency hopping protocol in which each hop of a number of hops spans one bit of single RFID device data. As described above, the frequency is set to fall within a band of frequencies allowed by regulatory authorities in a given jurisdiction. The transmitted power is also usually constrained by regulation.

The fast hop frequency hopping protocol includes frequency hops occurring at rates of up to 10 MHz to 50 MHz for operation complying with 900 MHz Part 15 rules, and frequency hops occurring up to 100 MHz for operation complying with 2.45 GHz Part 15 rules.

Process 100 sends (104) one or more commands to cause a RFID device to reply and transmits (106) a continuous wave un-modulated RF signal conforming to the fast hop frequency hopping protocol while listening for a RFID device response.

Process 100 receives (108) a RFID device response and reports (stores) (110) the RFID device response to a host computer.

Receiving (108) can include tracking data returned from the RFID device during a hop, and reconstructing (110) the returned data after the RF signal transmission is completed.

Embodiments of the invention can be implemented in digital electronic circuitry or digital combined with analog circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a logic circuit, a state machine, an ASIC, a computer, or multiple computers. A computer program can be written in any form of programming language, including compiled or interpreted languages, and it can be deployed in any form, including as a stand alone program or as a module, component, logic circuit, state machine, ASIC, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable or fixed processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit) or hard-wired logic control circuiting.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A method comprising:
transmitting from a radio frequency identification (RFID) interrogator a continuous wave un-modulated radio frequency (RF) signal conforming to a fast hop frequency hopping protocol in which each hop of a plurality of hops spans at least one bit but less than the totality of bits to be sent from a single RFID device data in a single communications session.

2. The method of claim 1 further comprising:
sending one or more commands to cause a RFID device to reply; and
transmitting a continuous wave un-modulated RF signal conforming to the fast hop frequency hopping protocol while listening for a RFID device response.

3. The method of claim 2 further comprising:
receiving a RFID device response; and
reporting the RFID device response to a computer linked to the RFID interrogator.

4. The method of claim 3 in which receiving comprises:
tracking data returned from the RFID device during a hop;
reconstructing the returned data after RF signal transmission is completed.

5. The method of claim 1 wherein the fast hop frequency hopping protocol comprises a frequency synthesizer using a digital waveform reconstruction with direct memory access (DMA) for frequency hopping spread spectrum (FH-SS) communications systems.

6. The method of claim 1 wherein the fast hop frequency hopping protocol comprises:
frequency hops occurring at rates of up to 10 MHz to 50 MHz for operation complying with 900 MHz Part 15 rules; and
frequency hops occurring up to 100 MHz for operation complying with 2.45 GHz Part 15 rules.

7. A method comprising:
in a radio frequency identification (RFID) interrogator, transmitting a command using a communication protocol to a RFID device; and
receiving a response from the RFID device conforming to a fast hop frequency hopping protocol.

8. The method of claim 7 in which the command comprises a parameter indicating a number of repetitions.

9. The method of claim 7 in which the command comprises a parameter indicating a hop rate.

10. The method of claim 7 in which the command comprises a parameter indicating a timing pulse parameter.

11. A radio frequency identification (RFID) interrogator comprising:
an integrated circuit, the integrated circuit coupled to a radio frequency (RF) transmitter through a digital-to-analog converter (DAC), the RF transmitter transmitting a continuous wave un-modulated radio frequency RF signal conforming to a fast hop frequency hopping protocol in which each hop of a plurality of hops at least spans one bit but less than the totality of bits to be sent from a single RFID device data in a single communication session.

12. The RFID interrogator of claim 11 in which the RF receiver enables receiving a RFID device response.

13. The RFID interrogator of claim 11 wherein the fast hop frequency hopping protocol comprises a frequency synthesizer using a digital waveform reconstruction with direct memory access (DMA) for frequency hopping spread spectrum (FH-SS) communications systems.

14. The RFID interrogator of claim 11 wherein the fast hop frequency hopping protocol comprises:
frequency hops occurring at rates of up to 10 MHz to 50 MHz for operation complying with 900 MHz Part 15 rules; and
frequency hops occurring up to 100 MHz for operation complying with 2.45 GHz Part 15 rules.

15. A radio frequency identification (RFID) device comprising:
an antenna linked to a transmit/receiving circuit, the transmit/receiving circuit configured to receive a continuous wave un-modulated radio frequency (RF) signal from a RFID interrogator, the RF signal conforming to a fast hop frequency hopping protocol in which each hop of a plurality of hops spans at least one bit but has then the totality of bits to be sent from a single RFID device data in a single commitment session; and
a microcontroller linked to the transmit/receiving circuit.

16. The RFID device of claim 15 in which the transmit/receiving circuit is further configured to transmit a RF signal conforming to the fast hop frequency hopping protocol in response to receiving the RF signal from the RFID interrogator.

17. The RFID device of claim 15 wherein the fast hop frequency hopping protocol comprises a frequency synthesizer using a digital waveform reconstruction with direct memory access (DMA) for frequency hopping spread spectrum (FH-SS) communications systems.

18. The RFID device of claim 15 in which the fast hop frequency hopping protocol comprises:
frequency hops occurring at rates of up to 10 MHz to 50 MHz for operation complying with 900 MHz Part 125 rules; and
frequency hops occurring up to 100 MHz for operation complying with 2.45 GHz Part 15 rules.
